(19) United States
(12) Patent Application Publication
(10) Pub. No.: US 2026/0367907 A1
(43) Pub. Date: Nov. 19, 2026

(54) SOFTWARE MANAGEMENT APPARATUS, SOFTWARE MANAGEMENT SYSTEM, SOFTWARE MANAGEMENT METHOD, AND PROGRAM RECORDING MEDIUM

(71) Applicant: NEC Corporation, Tokyo (JP)

(72) Inventor: Masahiko KIKUCHI, Tokyo (JP)

(73) Assignee: NEC Corporation, Tokyo (JP)

(21) Appl. No.: 19/154,077

(22) PCT Filed: Feb. 15, 2023
(86) PCT No.: PCT/JP2023/005263

§ 371 Date: Aug. 6, 2025

(51) Int. Cl. G06F 8/70; G06F 8/65

(52) U.S. Cl. CPC G06F 8/70; G06F 8/65

(57) ABSTRACT

The software management apparatus comprises: a memory configured to store instructions; and a processor configured to execute the instructions to: manage a parameter set applied to a computer program installed in a vehicle being managed; determine whether the parameter set applied to the vehicle needs to be changed when the computer program installed in the vehicle is updated; and transmit an appropriate parameter set to a vehicle determined that the parameter set needs to be changed as a result of the determination.

### TECHNICAL FIELD

The present invention relates to a software management apparatus, a software management system, a software management method, and a program recording medium.

### BACKGROUND ART

PTL 1 discloses an example of a vehicle optimization system including a model inspection/simulation unit. According to PTL 1, the model inspection/simulation unit is an example of a calculation unit that performs various calculations, and it is described that the model inspection/simulation unit performs calculation related to evaluation indices by performing model inspection and/or simulation (operation verification in test environment) based on user information, maintenance information, environment information, route information, and the like, design information (operation model, simulator, and the like), and information of an executable program and parameters for setting the program, and determines an optimum combination of a program and parameters for the evaluation indices based on a calculation result.

### CITATION LIST

### Patent Literature

PTL 1: WO 2019/131027 A1

### SUMMARY OF INVENTION

### Technical Problem

There is a problem that appropriate management becomes difficult for a vehicle unit under development (including an emulator and the like) because there are many various types of parameter sets assuming a real vehicle and such parameter sets are frequently changed. In recent years, the program of the vehicle is updated via wireless communication called over the air (OTA). When the program is updated using OTA or the like also for the vehicle unit under development, there is a possibility that inconsistency with parameters set for the vehicle unit under development or rewriting of an unintended parameter set is performed.

An object of the present disclosure is to provide a software management apparatus, a software management system, a software management method, and a program recording medium that can facilitate appropriate setting of a parameter set for a vehicle or the like under development described above.

### Solution to Problem

According to a first aspect, there is provided a software management apparatus including a management means for managing a parameter set applied to a computer program installed in a vehicle being managed, a determination means for determining whether the parameter set applied to the vehicle needs to be changed when the computer program installed in the vehicle is updated, and a transmission means for transmitting an appropriate parameter set to a vehicle determined that the parameter set needs to be changed as a result of the determination.

According to a second aspect, there is provided a software management system including the software management apparatus described above, and a developer terminal capable of browsing a content registered in the management means.

According to a third aspect, there is provided a software management method of allowing a computer capable of accessing a management means for managing a parameter set applied to a computer program installed in a vehicle being managed to perform determining whether the parameter set applied to the vehicle needs to be changed when the computer program installed in the vehicle is updated, and transmitting an appropriate parameter set to a vehicle determined that the parameter set needs to be changed as a result of the determination.

According to a fourth aspect, there is provided a program recording medium in which a program is recorded, the program causing a computer capable of accessing a management means for managing a parameter set applied to a computer program installed in a vehicle being managed to perform processing of determining whether the parameter set applied to the vehicle needs to be changed when the computer program installed in the vehicle is updated, and processing of transmitting an appropriate parameter set to a vehicle determined that the parameter set needs to be changed as a result of the determination.

### Advantageous Effects of Invention

According to the present disclosure, it is possible to facilitate appropriate setting of a parameter set for a vehicle or the like under development.

### BRIEF DESCRIPTION OF DRAWINGS

FIG. 1 is a diagram illustrating a configuration of an example embodiment of the present disclosure.

FIG. 2 is a flowchart illustrating an operation of the example embodiment of the present disclosure.

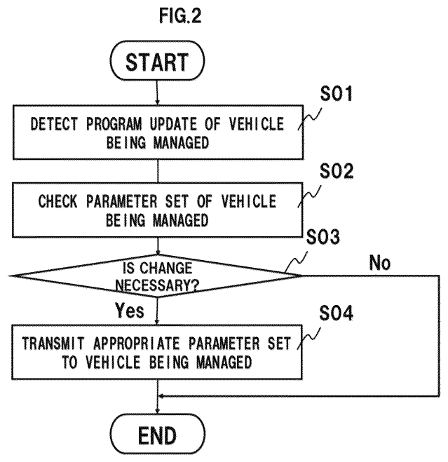

FIG. 3 is a diagram illustrating a configuration of a first example embodiment of the present disclosure.

FIG. 4 is a diagram illustrating an example of information stored in a parameter management unit of a software management apparatus according to the first example embodiment of the present disclosure.

FIG. 5 is a sequence diagram illustrating an operation of the first example embodiment of the present disclosure.

FIG. 6 is a diagram illustrating a configuration of a second example embodiment of the present disclosure.

FIG. 7 is a sequence diagram illustrating an operation of the second example embodiment of the present disclosure.

FIG. 8 is a diagram illustrating a configuration of a third example embodiment of the present disclosure.

FIG. 9 is a sequence diagram illustrating an operation of the third example embodiment of the present disclosure.

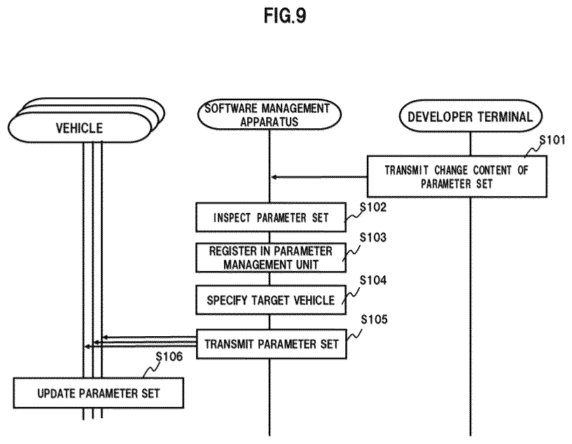

FIG. 10 is a diagram illustrating a configuration of a computer configuring a communication terminal of the present disclosure.

### EXAMPLE EMBODIMENT

First, an outline of example embodiments of the present disclosure will be described with reference to the drawings. Reference numerals assigned in the drawings of the outline are assigned to each element for convenience as an example for the sake of convenience to facilitate understanding, and are not intended to limit the present disclosure to any mode shown in drawings. An individual connection line between blocks in the drawings and the like referred to in the following description includes both bidirectional and unidirectional. A unidirectional arrow schematically indicates a flow of a principal signal (data), and does not exclude bidirectionality. A program is executed by a computer apparatus, and the computer apparatus includes, for example, a processor, a storage device, an input device, a communication interface, and a display device as necessary. The computer apparatus is configured to be communicable with devices (including a computer) inside or outside the device via a communication interface in a wired or wireless manner. Although there are ports and interfaces at connection points of input and output of each block in the relevant drawings, illustration of the port or interface is omitted.

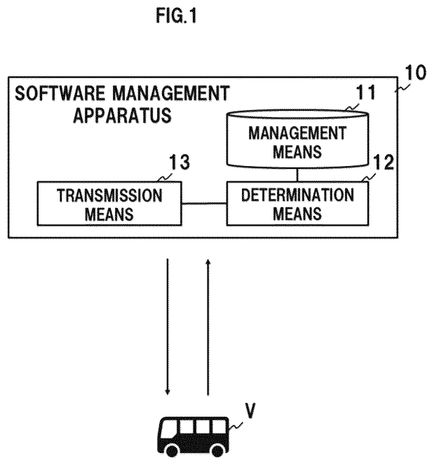

In the example embodiments, as illustrated in FIG. 1, the present disclosure can be achieved by a software management apparatus 10 including a management means 11, a determination means 12, and a transmission means 13.

More specifically, the management means 11 manages a parameter set applied to a computer program installed in a vehicle V being managed. The parameter set will be described as indicating one or more parameters set in an electronic control unit (ECU) or an in-vehicle device. Examples of the parameters include information related to an outer shape of the vehicle such as a size of a tire of the vehicle, a wheelbase, and a vehicle width, a replacement timing of a brake pad, and maintenance information on how to raise a fluid pressure of a brake.

The determination means 12 determines whether the parameter set applied to the vehicle needs to be changed when the computer program installed in the vehicle V is updated.

As a result of the determination, the transmission means 13 transmits an appropriate parameter set to a vehicle determined that the parameter set needs to be changed.

The software management apparatus 10 configured as described above operates as follows. First, the software management apparatus 10 detects update of a computer program installed in the vehicle V (step S01). Other methods may be adopted as a method of detecting update of the computer program. Examples of the method include a method of directly receiving a notification including a content of a parameter set from the vehicle V, and a method of inquiring of the vehicle V about a version and a parameter set of a computer program currently installed.

Next, the software management apparatus 10 refers to the content stored in the management means 11 and determines whether the parameter set applied to the vehicle needs to be changed (step S02). For example, when the parameter set is changed as a result of updating the computer program installed in the vehicle V, the software management apparatus 10 determines that the parameter set needs to be changed to restore the parameter set (Yes in step S03).

When determining that the parameter set needs to be changed, the software management apparatus 10 transmits an appropriate parameter set to the vehicle V (step S04). As described above, it is possible to prevent setting of an inappropriate parameter set due to update of a computer program installed in the vehicle V.

According to the software management apparatus 10 operating as described above, it is possible to facilitate appropriate setting of a parameter set for a vehicle or the like under development.

### First Example Embodiment

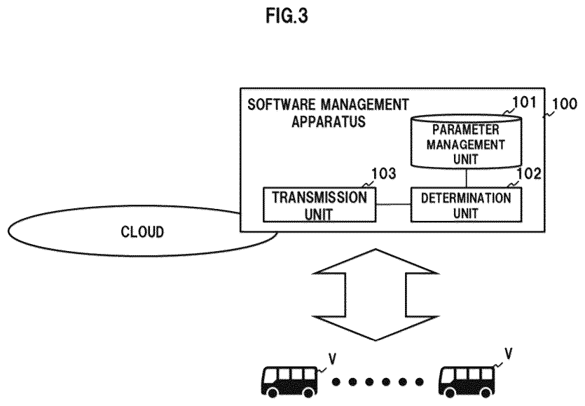

Next, a detailed description will be given to a first example embodiment in which checking of a parameter set is performed in response to an update completion notification of a program from a vehicle with reference to the drawings. FIG. 3 is a diagram illustrating a configuration of the first example embodiment of the present disclosure. Referring to FIG. 3, a configuration including a plurality of vehicles V and a software management apparatus 100 that checks whether appropriate parameters are set for the vehicles V is illustrated.

The vehicle V is a vehicle in which parameter sets such as a size of a tire of the vehicle, a wheelbase, and a method of raising fluid pressure of a brake are set in the ECU and other in-vehicle units. In the following description, it is assumed that the vehicle V has a function of updating a program installed in the ECU or other in-vehicle devices using OTA. The vehicle V may be a vehicle under development.

The software management apparatus 100 includes a parameter management unit 101, a determination unit 102, and a transmission unit 103. The parameter management unit 101, the determination unit 102, and the transmission unit 103 each correspond to the management means 11, the determination means 12, and the transmission means 13 described above.

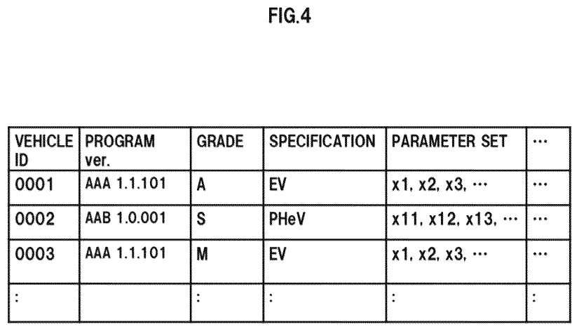

The parameter management unit 101 manages a parameter set applied to a computer program (hereinafter, a “program”) installed in the vehicle V. FIG. 4 is an example of a parameter set stored in the parameter management unit 101. In the example of FIG. 4, a parameter set is stored for each vehicle specified by a vehicle ID, in addition to a program and a version of the program, a grade of the vehicle, and a specification. Although one set of a program and a parameter set is illustrated in the example of FIG. 4, when there are a plurality of types of programs installed in the vehicle V, the parameter management unit 101 may manage a plurality of sets of programs and parameter sets.

The determination unit 102 determines whether the parameter set applied to the vehicle V of which an update notification of a program is received needs to be changed. As a method of determining whether the parameter set needs to be changed by the determination unit 102, it is possible to adopt a method in which the determination unit 102 inquires of the ECU or the like of the vehicle V to check the necessity. It is also possible to adopt a method of including a value of the parameter set in the update notification of the program from the vehicle V to the software management apparatus 100. When determining that the parameter set needs to be changed as a result of the determination, the determination unit 102 requests the transmission unit 103 to transmit an appropriate parameter set.

The transmission unit 103 transmits the appropriate parameter set to the vehicle V in response to the instruction from the determination unit 102. The transmission of the parameter set from the transmission unit 103 to the vehicle V may be performed via a wireless network such as a carrier communication network or road-to-vehicle communication.

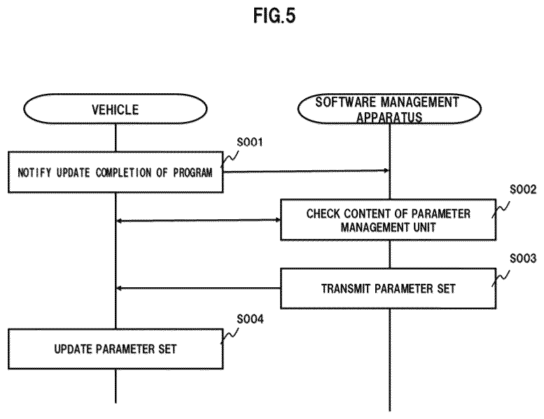

Next, the operation of the present example embodiment will be described in detail with reference to the drawings. FIG. 5 is a sequence diagram illustrating an operation of the first example embodiment. Referring to FIG. 5, first, an update completion notification of a program is transmitted from the vehicle V to the software management apparatus 100 (step S001). Note that the update completion notification of the program may be automatically transmitted from the vehicle V, but when such a function is not provided on the vehicle V side, the software management apparatus 100 may inquire of the vehicle V about the latest state at predetermined time intervals.

The software management apparatus 100 that received the update completion notification of the program communicates with the vehicle V and checks whether a parameter set conforming to data of a corresponding vehicle ID of the parameter management unit 101 is set (step S002). As a result of the checking, when the parameter set set in the vehicle V coincides with a content stored in the parameter management unit 101, the software management apparatus 100 determines that the parameter set does not need to be changed. Then, subsequent processing is omitted.

As a result of the checking, when it is determined that the parameter set needs to be changed, the software management apparatus 100 transmits an appropriate parameter set to the vehicle V (step S003). Upon receiving the parameter set, the vehicle V updates the received parameter set (step S004).

As described above, according to the present example embodiment, it is possible to eliminate parameter inconsistency due to update of a program.

### Second Example Embodiment

In the first example embodiment described above, the parameter set is transmitted to the vehicle V that received the update completion notification of the program, and meanwhile, a description will be given as to a second example embodiment in which a software management apparatus 100a actively searches for a target vehicle and transmits a parameter set.

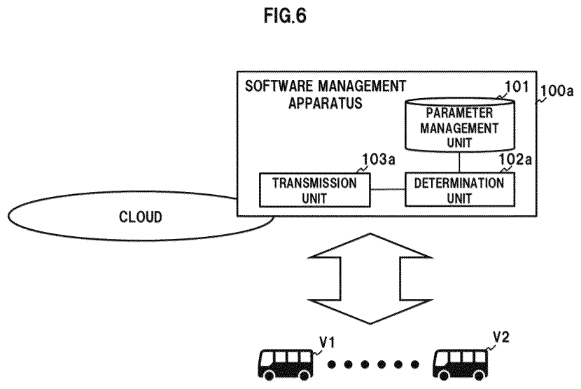

FIG. 6 is a diagram illustrating a configuration of the second example embodiment. A difference between the second example embodiment and the first example embodiment illustrated in FIG. 3 is in operations of a determination unit 102a and a transmission unit 103a. Since other configurations are similar to those of the first example embodiment, a difference between the example embodiments will be mainly described below.

When the determination unit 102a of the software management apparatus 100a of the present example embodiment determines that a parameter set applied to a certain vehicle VI needs to be changed, the determination unit searches for another vehicle V2 of which the parameter set needs to be changed with reference to the parameter management unit 101. Then, the determination unit 102a instructs the transmission unit 103a to transmit the parameter set. Here, at least one or more of an updated version of the computer program, a grade of the vehicle, and the specification can be used as a reference for the determination unit 102a to specify the another vehicle of which the parameter set needs to be changed.

The transmission unit 103a transmits an appropriate parameter set to the vehicle V2 in addition to the vehicle V1 in response to the instruction from the determination unit 102a.

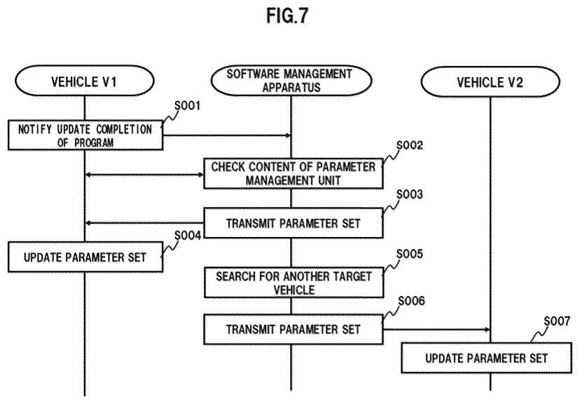

Next, the operation of the present example embodiment will be described in detail with reference to the drawings. FIG. 7 is a sequence diagram illustrating an operation of the second example embodiment. Since operations from steps S001 to S004 in FIG. 7 are similar to those in the first example embodiment, the description thereof will be omitted. After transmitting the parameter set to the vehicle V1, the software management apparatus 100a refers to the parameter management unit 101 and searches for another vehicle of which the parameter set needs to be changed (step S005). When another vehicle of which the parameter set needs to be changed is not found, the subsequent processing is omitted.

As a result of the checking, when another vehicle that requires a change in the parameter set is found, the software management apparatus 100a transmits an appropriate parameter set to the searched vehicle (for example, the vehicle V2 in FIG. 6) (step S006). Upon receiving the parameter set, the vehicle V2 updates the received parameter set (step S007).

As described above, according to the present example embodiment, in addition to the effects of the first example embodiment, it is possible to search for a vehicle having a high possibility of occurrence of parameter inconsistency and transmit an appropriate parameter set to the corresponding vehicle.

### Third Example Embodiment

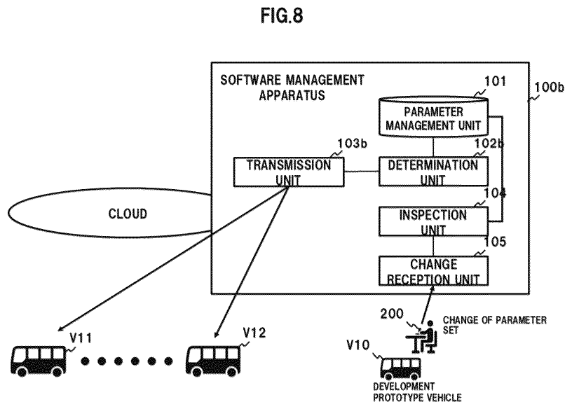

Next, a third example embodiment assumed to be used in a development environment in which a parameter set is changed will be described in detail with reference to the drawings. FIG. 8 is a diagram illustrating a configuration of the third example embodiment. A difference between the third example embodiment and the second example embodiment illustrated in FIG. 6 is that an inspection unit 104 and a change reception unit 105 are added to a software management apparatus 100b, and accordingly, the operations of the determination unit 102a and the transmission unit 103a are changed. Since other configurations are similar to those of the first and second example embodiments, differences between the example embodiments will be mainly described below.

The change reception unit 105 receives a change content of the parameter set from a developer terminal 200 of a developer in charge of testing a development prototype vehicle V10 equipped with a test unit and transmits the change content to the inspection unit 104. The developer terminal 200 can browse contents registered in the parameter management unit 101. A configuration including the software management apparatus 100b and the developer terminal 200 may configure a software management system.

The inspection unit 104 inspects the content of the parameter set received from the developer terminal 200. Note that various inspection contents of the parameter set in the inspection unit 104 may be considered. Very simply, the inspection may be an inspection of checking whether each value included in the parameter set falls within a certain range that can be set as each item. For example, the inspection may inspect consistency between each value included in the parameter set and a target vehicle. When the inspection is successful, the inspection unit 104 registers the value in the parameter management unit 101 as data of the development prototype vehicle V10.

When the contents of the parameter management unit 101 are updated, the determination unit 102b specifies other development prototype vehicles V11 and V12 of which the parameter sets need to be changed according to the change. The determination unit 102b instructs the transmission unit 103b to transmit the parameter sets to the vehicles.

The transmission unit 103b transmits the parameter sets to the development prototype vehicles V11 and V12 in response to the instruction from the determination unit 102b.

Next, the operation of the present example embodiment will be described in detail with reference to the drawings. FIG. 8 is a sequence diagram illustrating an operation of the third example embodiment. First, the terminal (developer terminal) 200 of a developer in charge of testing the development prototype vehicle V10 transmits a change content of the parameter set to the software management apparatus 100b (step S101).

The software management apparatus 100b that received the change content of the parameter set from the developer terminal 200 inspects the content of the received parameter set (step S102). As a result of the inspection, when there is no problem in the parameter set, the software management apparatus 100b registers the change content of the received parameter set in the parameter management unit 101 as data of the development prototype vehicle V10 (step S103).

The software management apparatus 100b specifies another vehicle of which the parameter set needs to be changed from the parameter management unit 101. When development prototype vehicles of which the parameter set needs to be changed are found as a result of the search, the determination unit 102b instructs the transmission unit 103b to transmit the parameter sets (step S104).

The transmission unit 103b that received the instruction transmits the parameter sets to the development prototype vehicles V11 and V12 (step S105). Upon receiving the parameter set, the vehicle V2 updates the received parameter set (step S007).

As described above, according to the present example embodiment, the change content of the parameter set performed in the process of testing the development prototype vehicle V10 can be reflected on other vehicles. In particular, in the process of development and trial production, parameters may be frequently changed every time a test is performed, and according to the present example embodiment, it is possible to perform search by the inspection unit 104 and then load the parameters in other target vehicles. It is possible to reduce occurrence of rework such as performing a test again due to parameter inconsistency or the like in other target vehicles.

As described above, since the developer terminal 200 is provided, according to the present example embodiment, centralized management of software for vehicles including a parameter set set for each development prototype vehicle is possible.

In the present example embodiment, in a more desirable mode, the parameter management unit 101 may store a change history of the parameter set. The change history of the parameter set may include a change content of the parameter set, a change date and time, and the like. The change history of the parameter set is configured to be browsable by the developer terminal 200 described above. It is possible to perform detailed analysis of a test result.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

### (Hardware Configuration)

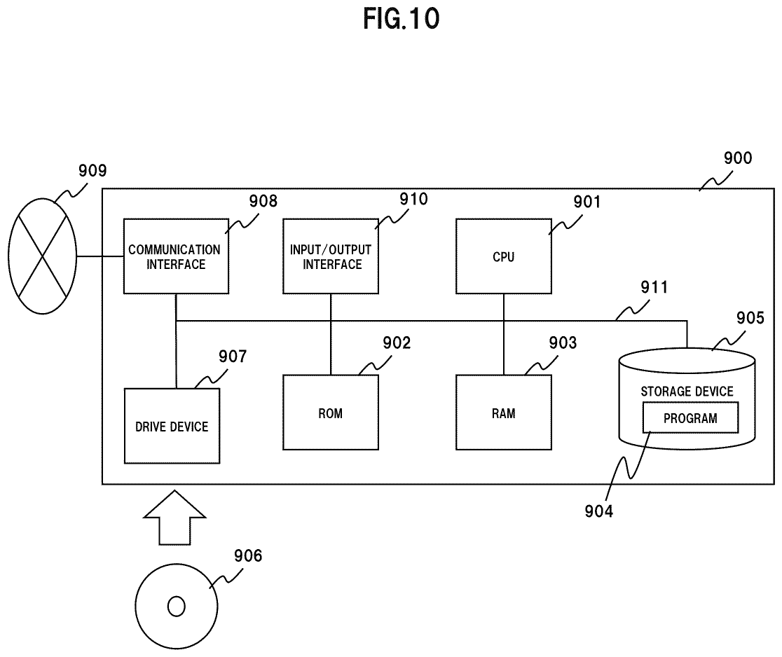

In each of the example embodiments of the present disclosure, each component of the apparatuses indicates a block of a functional unit. A part or all of the components of the apparatuses is achieved by, for example, any combination of an information processing apparatus 900 and a program, as illustrated in FIG. 10. FIG. 10 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 10 may execute a parameter set checking program and a transmission program to perform update processing of calculation parameters stored in the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of an event video creation apparatus described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

For example, in the first to third example embodiments described above, it is described that the vehicles V to V2 and the development prototype vehicles V10 to V12 have a function of updating a program by OTA, but the method of updating the program in the vehicles V to V10 is not limited to the description. For example, the present disclosure may also be applied to a case of updating the program using a tool for updating the program via an OBD2 socket.

The developer terminal 200 of the third example embodiment may also be provided as a terminal that can browse the contents registered in the parameter management unit 101 in the first and second example embodiments. Accordingly, centralized management of the parameter sets set for the vehicles is possible.

A part or all of the above example embodiments may be described as the following Supplementary Notes, but are not limited to the following.

### Supplementary Note 1

A software management apparatus including:
a management means for managing a parameter set applied to a computer program installed in a vehicle being managed;
a determination means for determining whether the parameter set applied to the vehicle needs to be changed when the computer program installed in the vehicle is updated; and
a transmission means for transmitting an appropriate parameter set to a vehicle determined that the parameter set needs to be changed as a result of the determination.

### Supplementary Note 2

The determination means of the software management apparatus may be configured to determine whether the parameter set applied to the vehicle needs to be changed based on a version of the computer program after update.

### Supplementary Note 3

The determination means of the software management apparatus may be configured to determine whether the parameter set applied to the vehicle needs to be changed based on at least one of a grade and a specification of the vehicle.

### Supplementary Note 4

Each of vehicles being managed by the software management apparatus is a development prototype vehicle equipped with a test unit,
the software management apparatus further includes
an inspection means for inspecting a change content of the parameter set transmitted from the development prototype vehicle, and
the software management apparatus may be configured to transmit the parameter set to other development prototype vehicles to which the parameter sets need to be applied when the inspection is successful.

### Supplementary Note 5

A software management system including the software management apparatus, and a terminal capable of browsing a content registered in the management means.

### Supplementary Note 6

A software management method of allowing a computer capable of accessing a management means for managing a parameter set applied to a computer program installed in a vehicle being managed to perform:
determining whether the parameter set applied to the vehicle needs to be changed when the computer program installed in the vehicle is updated; and
transmitting an appropriate parameter set to a vehicle determined that the parameter set needs to be changed as a result of the determination.

### Supplementary Note 7

A program recording medium in which a program is recorded, the program causing
a computer capable of accessing a management means for managing a parameter set applied to a computer program installed in a vehicle being managed to perform:
processing of determining whether the parameter set applied to the vehicle needs to be changed when the computer program installed in the vehicle is updated; and
processing of transmitting an appropriate parameter set to a vehicle determined that the parameter set needs to be changed as a result of the determination.

The modes described in the above supplementary notes may be combined with each other after being subjected to necessary modifications. For example, a configuration having both the content described in Supplementary Note 2 and the content described in any one or more of Supplementary Notes 3 and 4 is also included in the disclosure scope of the present specification.

The forms of Supplementary Notes 6 and 7 may be expanded to the forms of the Supplementary Notes 2 to 4, similarly to Supplementary Note 1.

The disclosures of each of the above PTLs is incorporated herein by reference, and may be used as the basis or a part of the present disclosure as necessary. Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed. Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

11 management means
12 determination means
13 transmission means
10 software management apparatus
100 software management apparatus
101 parameter management unit
102, 102a, 102b determination unit
103, 103a, 103b transmission unit
104 inspection unit
105 change reception unit
200 developer terminal
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus
V, V1, V2 vehicle
V10, V11, V12 development prototype vehicle

What is claimed is:

1. A software management apparatus comprising:
a memory configured to store instructions; and
a processor configured to execute the instructions to:
manage a parameter set applied to a computer program installed in a vehicle being managed;
determine whether the parameter set applied to the vehicle needs to be changed when the computer program installed in the vehicle is updated; and
transmit an appropriate parameter set to a vehicle determined that the parameter set needs to be changed as a result of the determination.

2. The software management apparatus according to claim 1, wherein the processor determine whether the parameter set applied to the vehicle needs to be changed based on a version of the computer program after update.

3. The software management apparatus according to claim 2, wherein the processor further determines whether the parameter set applied to the vehicle needs to be changed based on at least one of a grade and a specification of the vehicle.

4. The software management apparatus according to claim 1, wherein
each of vehicles being managed is a development prototype vehicle equipped with a test unit,
the processor further configured to execute the instructions to:
inspect a change content of the parameter set transmitted from the development prototype vehicle, and
the transmit the parameter sets to other development prototype vehicles to which the parameter sets need to be applied when the inspection is successful.

5. A software management system comprising:
a software management apparatus and a memory configured to store instructions; and a terminal capable of browsing a content registered in the software management apparatus;
wherein the software management apparatus comprising: a processor configured to execute the instructions to:
manage a parameter set applied to a computer program installed in a vehicle being managed;
determine whether the parameter set applied to the vehicle needs to be changed when the computer program installed in the vehicle is updated; and
transmit an appropriate parameter set to a vehicle determined that the parameter set needs to be changed as a result of the determination.

6. A software management method of allowing a computer capable of accessing a management means for managing a parameter set applied to a computer program installed in a vehicle being managed to perform:
determining whether the parameter set applied to the vehicle needs to be changed when the computer program installed in the vehicle is updated; and
transmitting an appropriate parameter set to a vehicle determined that the parameter set needs to be changed as a result of the determination.

7. (canceled)

8. The software management apparatus according to claim 2, wherein
each of vehicles being managed is a development prototype vehicle equipped with a test unit,
the processor further configured to execute the instructions to:
inspect a change content of the parameter set transmitted from the development prototype vehicle, and
transmit the parameter sets to other development prototype vehicles to which the parameter sets need to be applied when the inspection is successful.

9. The software management apparatus according to claim 3, wherein
each of vehicles being managed is a development prototype vehicle equipped with a test unit,
the processor further configured to execute the instructions to:
inspect a change content of the parameter set transmitted from the development prototype vehicle, and
transmit the parameter sets to other development prototype vehicles to which the parameter sets need to be applied when the inspection is successful.
